(19) United States
(12) Patent Application Publication
(10) Pub. No.: US 2012/0078572 A1
(43) Pub. Date: Mar. 29, 2012

(54) Road Surface Condition Estimating Device and Method

(75) Inventors: Mikio Bando, Mito (JP); Yukihiro Kawamata, Hitachi (JP); Toshiyuki Aoki, Hitachi (JP)

(73) Assignee: HITACHI, LTD., Tokyo (JP)

(21) Appl. No.: 13/228,126

(22) Filed: Sep. 8, 2011

(30) Foreign Application Priority Data
Sep. 29, 2010 (JP) 2010-218049

(51) Int. Cl. G06F 15/00

(52) U.S. Cl. 702/150

(57) ABSTRACT

A road surface condition estimating device includes an undulation estimating portion for estimating undulations on the trajectory of a traveling vehicle from behavioral information about plural vehicles collected during travel of the vehicles, and a rut estimating portion for estimating undulations of ruts relative to the trajectories of the vehicles from the trajectories of traveling vehicles and from the behavioral information about the vehicles. The behavioral information includes information about positions, postures, and speeds of travel of the vehicles. Undulations on the trajectory of each traveling vehicle found by the undulation estimating portion and undulations of ruts relative to the trajectory of the traveling vehicle are superimposed for each vehicle to find road surface conditions, which are delivered to the vehicles.

### BACKGROUND OF THE INVENTION

The present invention relates to a device for estimating road surface conditions using the swept path of an object in motion.

As a technique for reflecting road surface conditions in vehicle learning, patents (such as patent document 1 (JP-A-2009-107584) for causing the results of learning operation to know whether there are road irregularities to be written into map data and to be used for control of the suspension system and speed have been disclosed.

Furthermore, patent document 2 (JP-A-2006-153714) sets forth a technique for estimating undulations from data such as about vibrations and recording the positions of the undulations as a technique for obtaining information about road surface conditions such as road surface undulations. Patent document 3 (JP-A-4-115398) discloses a technique using acceleration data. Patent document 4 (JP-A-2006-53757) and patent document 5 (JP-A-2004-151883) disclose techniques using camera images. In addition, patent document 6 (JP-A-2006-239117) sets forth a technique of providing a more accurate estimate of whether there is an undulation by the use of map data and by setting a threshold value for obtained acceleration data. Patent document 7 (JP-A-2008-185418) sets forth a technique of providing an accurate estimate of road surfaces free from the effects of road surface tilts by the use of information obtained from sensors mounted to the vehicle itself and information about the suspension system. Patent document 8 (JP-A-2005-182405) sets forth a technique of controlling vehicles by receiving, via communications, road surface information obtained from the plural vehicles.

These related art techniques make it possible that road surface information is obtained by previous measurements and estimates the conditions of the road surface at positions that the subject vehicle will cross in a case where other vehicle traveled on the road surface and made the measurements.

### SUMMARY OF THE INVENTION

However, where the road to be traveled is an unpaved soft road surface such as a soil road, undulations created by ruts of vehicles are located outside the tires and so it is difficult to make measurements using the vehicle alone. Furthermore, during normal vehicle travel, the vehicle often travels along ruts and, therefore, undulations created by the ruts are not measured. Consequently, in a case where the road assumed by the present vehicle crosses such ruts, it is highly likely that the road surface is in a state different from the road surface measured by other vehicle. Road surface conditions estimated by the related art do not take these points into account. Rather, a great deviation occurs from the road surface conditions occurring after passage of a vehicle. This can create a condition in which it is difficult for a following vehicle to control the vehicle itself appropriately.

The present invention provides a road surface condition estimating device having a vehicle information acquisition unit for acquiring behavioral information about behavior of plural vehicles collected during their travel and an all vehicle trajectory database for storing trajectories of positions traveled by the vehicles. The behavioral information includes information about positions, postures, and travel speeds of the vehicles. The road surface condition estimating device further includes an undulation estimating unit which estimates undulations of the trajectories of the positions traveled by the vehicles from the behavioral information about the vehicles and a rut estimating unit which estimates undulations of ruts relative to the trajectories of the vehicles from the trajectories of the positions traveled by the vehicles and from the behavioral information about the vehicles. For each of the vehicles, the undulations on the trajectory of the traveling vehicle found by the undulation estimating unit and the undulations of ruts relative to the trajectory of the traveling vehicle found by the rut estimating unit are superimposed to find road surface conditions, which are delivered to the vehicles.

For a road whose surface geometry tends to vary, a vehicle which gathered information about trajectories drawn by running vehicles to estimate the road surface conditions estimates variations of undulations formed on the ruts by the vehicle's travel and superimposes the estimated variations onto the vehicle's trajectory. Thus, road surface conditions that would occur after a run of a vehicle is estimated, and the information is fed back to the vehicle. In consequence, undulations created by ruts and not measured heretofore can be reflected in the road surface conditions. As a result, safer control of deceleration and warning can be done.

The other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram of a system having a road surface estimating function.

FIG. 2 is a diagram illustrating the data structure of an all vehicle trajectory database.

FIG. 3 is a diagram illustrating the data structure of a currently measured road surface condition map and of a road surface condition map.

FIG. 4 is a diagram illustrating the data structure of an all vehicle specification database.

FIG. 5 is a diagram illustrating the data structure of an all vehicle sensor information database.

FIG. 6 is a diagram illustrating the configuration of a rut estimating portion.

FIG. 7 is a flowchart for estimating undulations caused by ruts.

FIG. 8 is a flowchart for estimating an undulation variation rate.

### DETAILED DESCRIPTION OF THE INVENTION

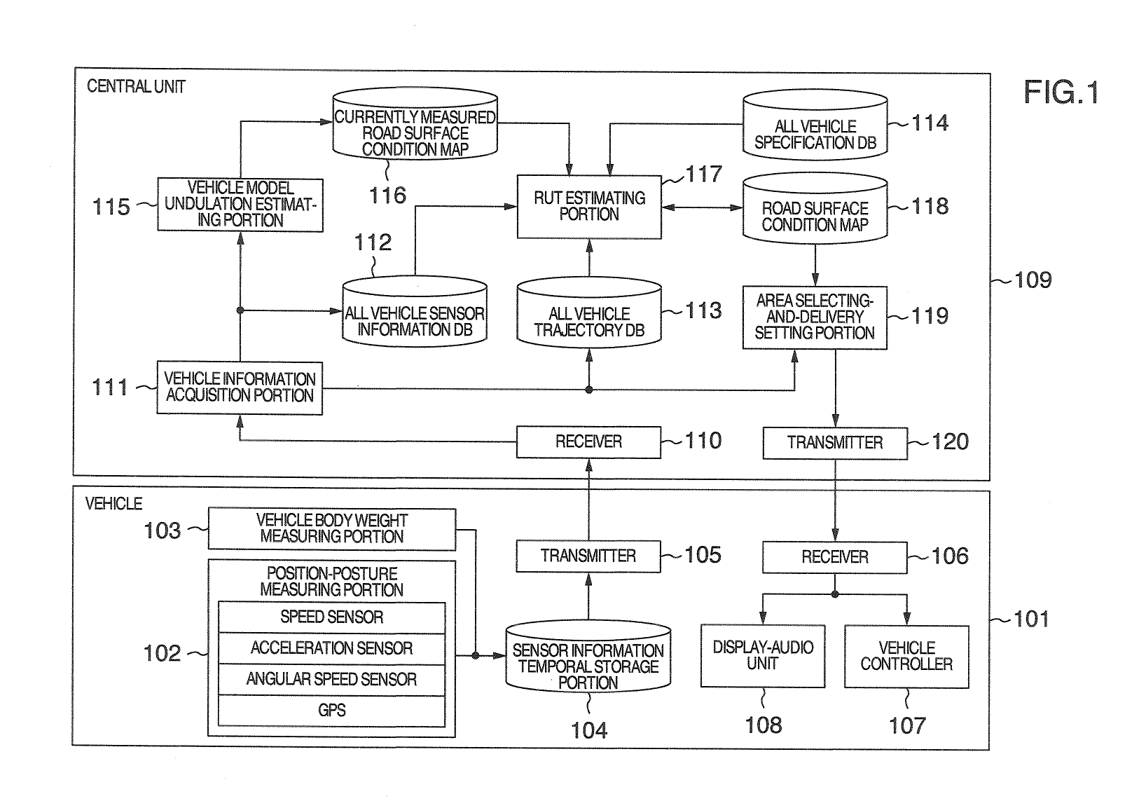

The configurations of a vehicle and a central unit which accomplish a road surface estimating function are schematically shown in FIG. 1.

The vehicle, indicated by reference numeral 101, has a position-posture measuring portion 102 for measuring the current position (coordinates) and the posture of the body of the vehicle in motion by the use of a GPU device, a vehicle speed sensor, an acceleration sensor, and an angular velocity sensor (such as a gyroscope sensor), a vehicle body weight measuring portion 103 for measuring the weight of the body of the vehicle, a sensor information temporal storage portion 104 for temporarily storing these kinds of data, a transmitter 105 for sending these kinds of information to the central unit, 109, via communications, a receiver 106 for receiving information from the central unit 109, a vehicle controller 107 for controlling the vehicle based on the received data about the road surface conditions, and a display-audio unit 108 for providing a warning display or audible notice to the effect that road surfaces to be encountered soon have undulations on the in-vehicle display (not shown) based on the received data about the road surface conditions.

The vehicle 101 stores the information about the weight of the body of the vehicle and information from the sensors in the sensor information temporal storage portion 104, the information being collected at regular intervals of time. The sensor information collected at regular intervals is sent to the central unit 109 at certain intervals of time. Sensor information being collected is not sent to the central unit 109. It is assumed that the various sets of sensor information are synchronized by instants of time found from a received GPS signal. It is also assumed that there are similar plural vehicles and that the vehicles are communicating with the central unit 109. Transmission is performed from the transmitter 105 to the central unit 109 at the timings at which the transmitter is in a transmissible state and under the condition where the collected sensor information stays in the sensor information temporal storage portion 104 for a given interval of time or longer. The sensor information sent from the transmitter 105 includes information indicating the instant at which the sensor information was acquired, vehicle motion information consisting of pieces of information indicating the position, the orientation of travel, and the speed of travel of the vehicle measured using data delivered from the GPS device or from the vehicle speed sensor, acceleration sensor, and angular speed sensor, as well as output data from the vehicle speed sensor, acceleration sensor, and angular speed sensor.

The information that the vehicle 101 receives from the central unit 109 indicates the road surface conditions of the route to be followed by the vehicle. Based on the information, the vehicle controller 107 controls the acceleration or deceleration, manipulates the steering wheel, and performs other operations. Visual notice of the road surface conditions or other information is provided on the in-vehicle display.

The central unit 109 has a receiver 110 receiving information from the plural vehicles 101, a vehicle information acquisition portion 111 for obtaining vehicle motion information (i.e., data about a vehicle ID intrinsic to each vehicle, the position, the orientation of travel, speed of travel of the vehicle, and the instants at which these pieces of data were obtained) from the information obtained by the receiver 110, the weight of the body of the vehicle, and sensor data including speed sensor output data, acceleration sensor output data, and angular speed sensor output data for each vehicle, and finding an area number assigned to the area where the vehicle is present from the vehicle's position included in the obtained vehicle motion information, an all vehicle sensor information database (DB) 112 for storing the vehicle motion information, vehicle body weight, sensor information, and the area number assigned to the area where the vehicle is present that are obtained by the vehicle information acquisition portion 111 for each vehicle, and an all vehicle trajectory database (DB) 113 for causing positional data included in the vehicle motion information about the plural vehicles obtained by the vehicle information acquisition portion 111 to be stored in a time sequential order. In the description of the present embodiment, it is assumed that a geographic region is divided into rectangular areas latitudinally and longitudinally, that an area number is assigned to each area, and that a corresponding area is determined from the latitude and longitude included in the positional information obtained by the vehicle information acquisition portion. Besides, a geographic region may be split into polygonal areas rather than rectangular areas. In this case, the area in which the vehicle is located is determined by what polygonal area is the vehicle positioned.

Furthermore, the central unit 109 includes an all vehicle specification database (DB) 114 in which dimension information (such as vehicle width and total length) about every vehicle to be managed is stored. The central unit 109 has a vehicle model undulation estimating portion 115 for calculating the amount of undulation of a road surface along which a vehicle has traveled from positional information included in the vehicle motion information about each vehicle obtained by the vehicle information acquisition portion 111 and also from the sensor data based on a vehicle model, a currently measured road surface condition map 116 including a database of amounts of undulations of road surfaces calculated (hereinafter referred to as the measured amounts of undulations) by the vehicle model undulation estimating portion 115, a rut estimating portion 117 for obtaining vehicle trajectories from the all vehicle trajectory database 113, combining the results of calculations of undulations previously stored in the currently measured road surface condition map 116 with the results of estimation of an undulation created by passage of the vehicle, and estimating road surface conditions in which variations of undulations due to the ruts created by passage of each vehicle are reflected, a road surface condition map 118 including a database of road surface conditions in which the undulations due to the ruts estimated by the rut estimating portion 117 are reflected, an area selecting-and-delivery setting portion 119 for determining to what vehicle is data about the road surface conditions about what area is sent based on positional information about each vehicle obtained from the road surface condition map 118 and from the vehicle information acquisition portion 111, and a transmitter 120 for sending the information to each vehicle.

In the area selecting-and-delivery setting portion 119, the road surface conditions of each area are obtained from the created road surface condition map 118. The conditions of the road surface of the area on which each vehicle is traveling are identified from the vehicle ID obtained by the vehicle information acquisition portion 111 and from the area number. Information about the identified conditions is output to each vehicle from the transmitter 120.

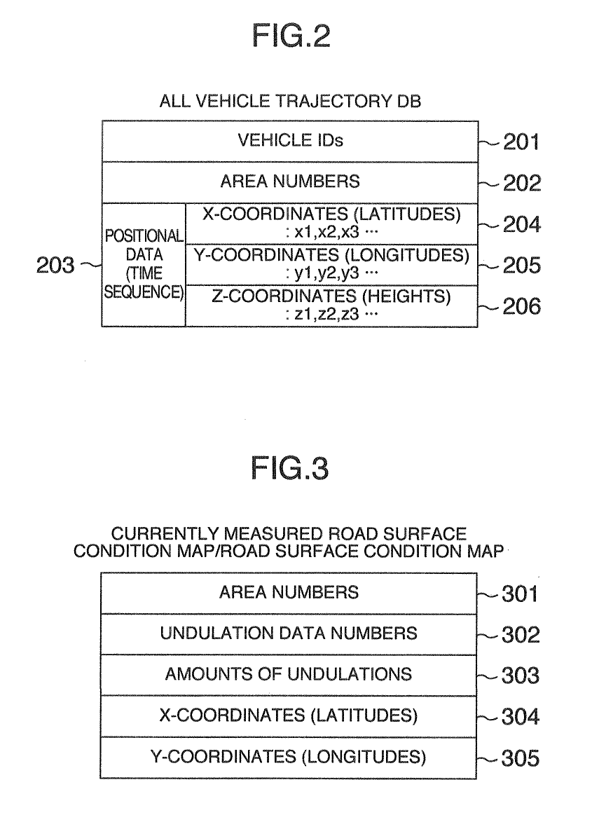

The data structure of the all vehicle trajectory database 113 is shown in FIG. 2. This database holds a time sequential arrangement of vehicle IDs 201 for identifying what vehicle the information indicates among the plural vehicles, area numbers 202 indicating from what area was the data obtained, and positional data 203 about the measured ruts. Vehicle motion trajectory data sets for the individual areas are separately stored. The positional data 203 consists of three-dimensional coordinates (x-coordinate (latitude) 204, y-coordinate (longitude) 205, and z-coordinate (height) 206) indicating the position of each vehicle and arranged in time sequential order. As described previously, an area is a geographic area defined by a rectangle which is partitioned off in a parallel manner to a latitude and a longitude starting at some point. A geographic region managed by the central unit is partitioned into equal rectangles. Numbers are assigned in succession to the rectangular areas from the most northward and most westward area. For example, assuming that the area managed by the central unit lies within a rectangular range that covers an area 4 km square from some point, 16 (4×4) small rectangular areas each partitioned off can be set.

The data structure of the currently measured road surface condition map 116 and of the road surface condition map 118 are shown in FIG. 3. The currently measured road surface condition map 116 and the road surface condition map 118 have the same data structure. Each map has area numbers 301, undulation data numbers 302, amounts of undulations 303 indicating the amplitudes of the undulations, and coordinates (x-coordinates (latitudes) 304 and y-coordinate (longitudes) 305) indicating the positions of the undulations. The currently measured road surface condition map 116 indicates the newest road surface conditions among road surface conditions calculated based on the results of the measurements made by the vehicle, but undulation variations caused by passage of the vehicle are not reflected. Consequently, it follows that the road surface conditions were produced immediately prior to the newest conditions. On the other hand, the road surface condition map 118 is a map giving an estimate of the temporally newest road surface conditions.

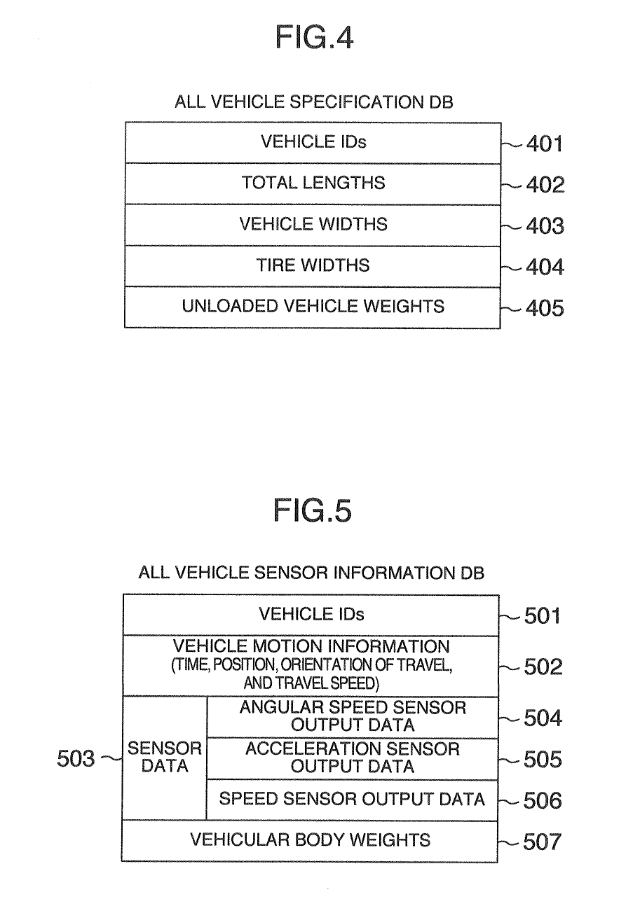

The data structure of the all vehicle specification database 114 is shown in FIG. 4. The database 114 includes vehicle IDs 401 intrinsic to the individual vehicles and various sets of dimensions of each vehicle such as the total lengths 402, vehicle widths 403, tire widths 404, and unloaded vehicle weights 405.

The data structure of the all vehicle sensor information database 112 is shown in FIG. 5. Stored in the database 112 are vehicle IDs 501 intrinsic to the individual vehicles, vehicle motion information 502 including time data synchronized with time information obtained from the GPS signal received by each vehicle, position, orientation of travel, and speed of travel measured by each vehicle, sensor data 503 including speed sensor output data 504, acceleration sensor output data 505, and speed sensor output data 506, and vehicle body weights 507.

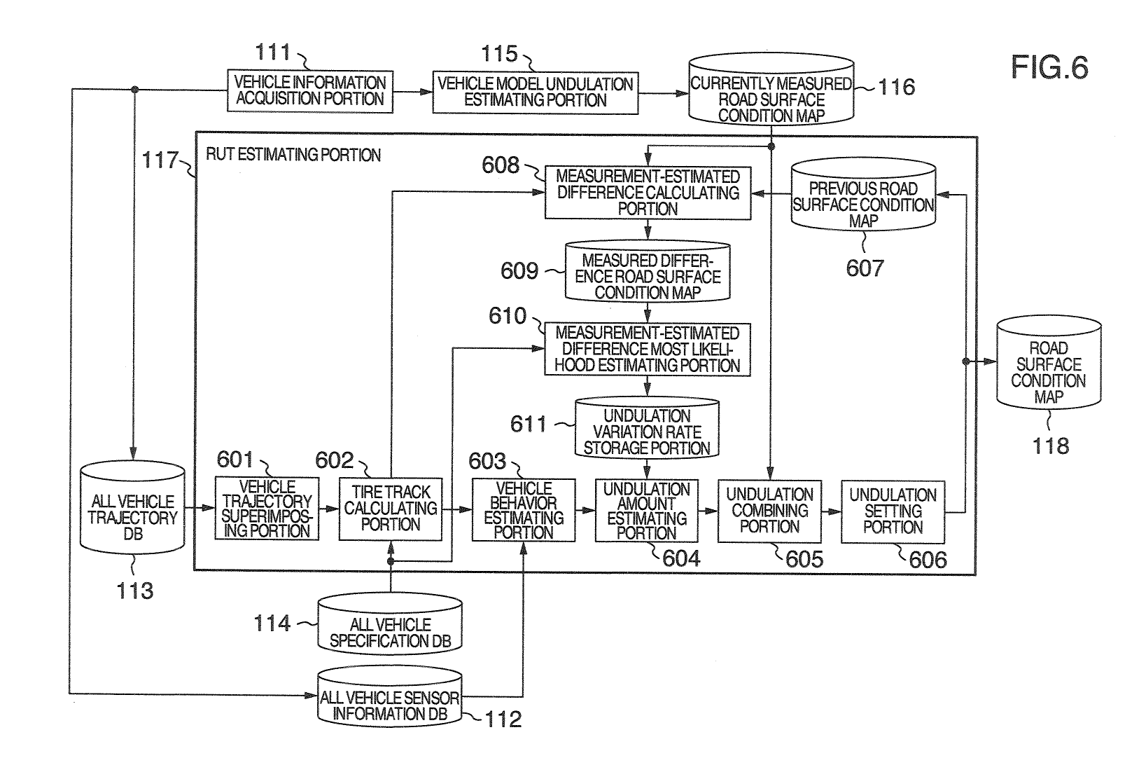

The configuration of the rut estimating portion 117 is shown in FIG. 6. In the rut estimating portion 117, a vehicle trajectory superimposing portion 601 reads the swept paths of all the vehicles from the all vehicle trajectory database 113 and superimposes the swept paths of all the vehicles for each individual area. In a tire trajectory calculating portion 602, the obtained trajectories of the travel of the vehicles are converted into tire tracks that are impressions left by passage of vehicle tires. A vehicle behavior estimating portion 603 obtains the body weight of each vehicle, speed of travel, and angular speed sensor output or orientation of travel from the all vehicle sensor information database 112, in which the sensor information obtained from the vehicle information acquisition portion 111 is stored, and estimates the motion behavior of each vehicle such as straight movement, turn, and quick acceleration or deceleration from time-series data about the tire track positions produced by a tire track calculating portion 602. An undulation amount estimating portion 604 estimates the amount of undulation due to ruts created by the vehicle from the undulation variation rate of the area corresponding to the motional behavior based on the estimated motional behavior of the vehicle. An undulation combining portion 605 obtains a measured amount of undulation (i.e., measured magnitude of undulation) from the currently measured road surface condition map 116 and combines this with the amount of undulation due to the ruts estimated by the undulation amount estimating portion 604 to create a new amount of undulation of the road surface (hereinafter referred to as the estimated amount of undulation) occurring after passage of the vehicle. An undulation setting portion 606 registers undulations having combined amounts of undulations into the road surface condition map 118.

In the rut estimating portion 117, the road surface conditions registered in the road surface condition map 118 in the previous processing session are stored in a previous road surface condition map 607. A measurement-estimated difference calculating portion 608 calculates the difference between the newest measured undulation amount estimated by the vehicle model undulation estimating portion 115 and stored in the currently measured road surface condition map 116 and the amount of undulation estimated by the previous processing session by the rut estimating portion 117 stored in the previous road surface condition map 607 in a corresponding manner to the series data about the positions of the tire tracks produced by the tire track calculating portion 602. The differential amounts of undulations outputted from the measurement-estimated difference calculating portion 608, i.e., the difference between the measured amount of undulation and the estimated amount of undulation obtained the previous time for each geographic point, are stored in a measured difference road surface condition map 609.

A measurement-estimated difference maximum likelihood estimating portion 610 calculates a maximum likelihood estimate of the rate of variation of undulation, i.e., an amount of undulation created whenever a vehicle drives once, from the difference between the measured newest amount of undulation and the amount of undulation estimated the previous time. At this time, a recess of a normal distribution centered at the position of the tire track is postulated, the distribution having a vehicle body weight and a speed as weights. The size of the recess is varied depending on whether the vehicle goes straight or turns. An amount of recess obtained by summing up amounts of recess at the same position is taken as the recess at that position and compared with recesses or convexes stored in the road surface conditions measured by the vehicle. A recess or convex having a larger absolute value at each geographic point is taken as the undulation at that point due to a rut. In addition, in a case where undulations due to ruts can be measured in practice, the amount of undulation created by a single passage of the vehicle is computed from the weight of the vehicle that passed across the position and from the number of passes, and learning is done.

The maximum likelihood estimate of the undulation variation rate computed by the measurement-estimated difference maximum likelihood estimating portion 610 is stored in an undulation variation rate storage portion 611.

The undulation amount estimating portion 604 reads the maximum likelihood estimate of the undulation variation rate from the undulation variation rate storage portion 611 and estimates the amount of undulation due to ruts using the read maximum likelihood estimate as an undulation variation rate corresponding to the vehicle behavior.

Processing for creating the road surface condition map 118 using information about undulations measured based on data obtained from each vehicle 101 is next described in detail.

The vehicle information acquisition portion 111 outputs the output data from each sensor and vehicle positions obtained from the vehicles 101 to the vehicle model undulation estimating portion 115, together with the vehicle IDs of the vehicles as described previously. With respect to the position of each vehicle, the area number assigned to a geographic area in which the current position is located is found. Vehicle positions are written as time-series data also into the all vehicle trajectory database 113 for each area number. Furthermore, vehicle motion information including vehicle body weight, measurement instant, position assumed at that instant, orientation of travel, and speed of travel is copied from each vehicle 101 into the all vehicle sensor information database 112, together with the obtained sensor data.

The vehicle model undulation estimating portion 115 can calculate the undulation of a road surface by introducing sensor data measured by the position-posture measuring portion of the vehicle 101 and the vehicle body weight measured by the vehicle body weight measuring portion 103 into a vehicle model by the use of a method as shown in the patent document 7. The calculated amounts of undulation or measured amounts of undulation are written into the currently measured road surface condition map 116 together with the positions. Where plural vehicles are driving across the same geographic point and the value of undulation is varying, the most newly calculated undulation in terms of the time found from the GPS signal is registered into the currently measured road surface condition map 116.

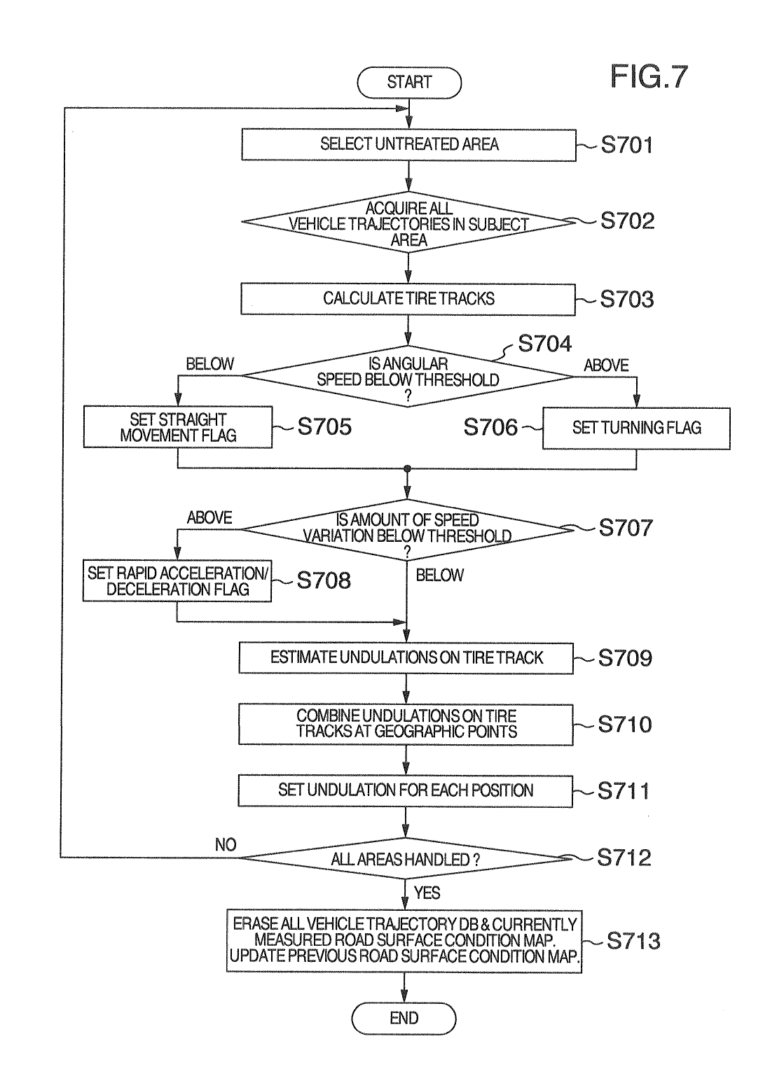

A flowchart illustrating processing steps for estimating the amount of undulation of a road surface by the rut estimating portion 117 in such a way that undulations due to ruts are reflected is shown in FIG. 7.

First, in step S701, an area in which an undulation due to a rut is estimated is selected. Choices are made in turn from among unprocessed areas from the area having a minimum number.

Then, in step S702, the vehicle trajectory superimposing portion 601 obtains trajectory data about all the vehicles only in the selected area from the all vehicle trajectory database 113.

Then, in step S703, the tire track calculating portion 602 calculates tire tracks that are positions traveled by the tires of the vehicles, using the previously registered vehicle widths 403 for the vehicle IDs by referring to the all vehicle specification database 114. At this time, it is assumed that the vehicle position corresponding to the trajectory data about the vehicle is the position of the central point of the vehicle body. The tire position of each vehicle is calculated as a position spaced from the central point by a distance equal to a half of the vehicle width in a direction normal to the vehicle's motion vector. The tire track calculating portion 602 outputs a sequence of positions of the tire track found in this way. With respect to the tire track position sequence, the same number is assigned to one sequence of positions. Their coordinates (longitudes and latitudes) are linked to the sequence of positions. In addition, as described later, when the undulation variation rate in each area is computed, it is assumed that the calculated position sequence of the tire track is kept stored in the tire track calculating portion 602 until the measurement-estimated difference calculating portion 608 reads out the position sequence in order to calculate the amount of difference between the measurement of an undulation at each geographic point and the amount of undulation estimated the previous time.

Then, in step S704, the vehicle behavior estimating portion 603 reads vehicular angular speed sensor output data from the all vehicle sensor information database 112 and makes a decision as to whether the vehicle of interest is going straight or turning. If the value of the angular speed sensor output data is equal to or less than a certain threshold value, then it is determined that the vehicle is going straight and control proceeds to step S705. If the value is in excess of the threshold value, it is determined that the vehicle is turning and control goes to step S706. In step S705, a flag (hereinafter may be referred to as the straight movement flag) indicating straight movement is set. In step S706, a flag (hereinafter may be referred to as the turning flag) indicating a turn is set.

Subsequently, the vehicle behavior estimating portion 603 makes a decision as to whether there is a rapid acceleration or deceleration in step S707 according to the calculated value of the difference between the value taken one sampling instant earlier and the current value of the speed of travel of each vehicle obtained from the vehicle information acquisition portion 111. It is assumed that the sampling period included in the vehicle speed information obeys the sampling period of the position-posture measuring portion 102. If the absolute value of the difference with the previously taken value is in excess of a given threshold value, it is determined that there was a rapid acceleration or deceleration, and control goes to step S708; otherwise, control passes to step S709. In step S708, it has been determined that there was a rapid acceleration or deceleration and so a flag indicating a rapid acceleration or deceleration (hereinafter may be referred to as the rapid acceleration/deceleration flag) is set. When a decision is made as to whether there was a rapid acceleration or deceleration, vehicular acceleration sensor output data stored in the all vehicle sensor information database 112 may be used.

In step S709, the undulation amount estimating portion 604 estimates the amount of undulation due to ruts on tire tracks. For the area of interest, the amount of undulation due to ruts is estimated from the result of estimation of the vehicle behavior (state indicated by the straight movement flag, turning flag, or rapid acceleration/deceleration flag) outputted by the vehicle behavior estimating portion 603 and from the undulation variation rate that is the standard deviation of amounts of deviations created by a single travel of a vehicle having some body weight. The undulation variation rate of the area varies according to the vehicular body weight in each area. The values are stored in the undulation variation rate storage portion 611 for each range of vehicular body weights. In this example, it is assumed that after a vehicle drove, an undulation of a normal distribution is created about the central point of the vehicle. Since the undulation variation rate is the standard deviation of amounts of undulations produced by a single run of the vehicle, the amount of undulation is maximized at the central point of the vehicle and decreases away from the central point, showing a normal distribution. Hence, amounts of undulation can be calculated. An undulation due to ruts is estimated or determined according to the straight movement flag set or reset in step S705 or the turning flag set or reset in step S706. If the straight movement flag is set, soil is ground uniformly across the tire tracks of the left and right road wheels. On the other hand, if the turning flag is set, greater force is applied to the tires on the opposite side of the direction of turn, thus grinding soil more deeply. Therefore, the central point of the vehicle located in the average point of the normal distribution deviates away from the direction of turn. More soil is ground in the tire track on the opposite side of the direction of turn than in the tire track on the same side as the direction of turn. The amount of ground soil is found from the undulation variation rate.

An amount of undulation 1 due to ruts on a tire track can be found according to the following Eq. (1).

$$1 ( j ) = \frac{k}{\sqrt{2 π} {l}_{0} ( j , M )} {e}^{- \frac{{( x - w )}^{2}}{8 {{l}_{0} ( j , M )}^{2}}} \qquad ( 1 )$$

where 1(j) is an amount of deviation (in m) in an area having an area number of j, x is the width of a vehicle (in m), M is the weight of the body of the vehicle, l₀(j,M) is an undulation variation rate to which the body weight M of the vehicle corresponds in the area j, and w is an amount of deviation from the central point of the vehicle due to a turn.

Eq. (1) is a function of a distance from the central point of the vehicle to the point of a tire track. The amount of deviation is maximized at the central point of the vehicle in a virtual manner. The point of the tire track is just located at a point given by the standard deviation. The undulation variation rate in each area is set for each range of the body weights of vehicles as described previously. Consequently, the value of the undulation variation rate l₀(j,M) that is set for the body weight range in which the body weight M of the vehicle to be treated falls in the area having the area number j is used.

If the turning flag is set, the average of the amounts of undulations in a normal distribution deviates w from the central point of the vehicle. This value can be found using the following Eq. (2). Assuming that the roll angle ζ of the vehicle body is uniquely determined from the body weight M of the vehicle and from the lateral acceleration on the vehicle, the lateral acceleration on the vehicle is determined from the speed V of the vehicle and from the angular speed Ω. The speed V and angular speed Ω are found from the vehicle speeds recorded in the all vehicle sensor information database 112 and from values indicated by the angular speed sensor output data.

$$w = \frac{x}{2} cos ξ ( M , V , Ω ) \qquad ( 2 )$$

where x is the width (in m) of the vehicle, w is an amount of deviation from the central point of the vehicle due to a turn, ξ is a roll angle of the vehicle body determined by the lateral acceleration, M is the weight (kg) of the vehicle body, V is a vehicle speed (in m/s), and Ω is an angular speed (in rad/s) of the vehicle.

If the rapid acceleration/deceleration flag is set, a value corresponding to the acceleration or deceleration on the vehicle is substituted into k of Eq. (1) and Eq. (1) is calculated, where k is a constant determined relative to the acceleration or deceleration. It is assumed that the relation with acceleration or deceleration on the vehicle has been previously determined. For example, if the rapid acceleration/deceleration flag is set, k is set to 1.5. If the rapid acceleration/deceleration flag is not set, k assumes its initial value of 1.

In step S710, the undulation combining portion 605 acquires a measured amount of undulation of a road surface in the area of interest from the currently measured road surface condition map 116. The undulation amount estimating portion 604 obtains the positions and sizes of undulations due to ruts and combines the undulations to thereby find an estimated amount of undulation on the tire tracks at each geographic point. The combination is carried out by simply adding the sizes of undulations due to ruts to the measured amounts of undulations of the road surface for each geographic point.

In step S711, the undulation setting portion 606 sets the estimated amounts of undulations found by the undulation combining portion 605 in step S710 at the positions of the undulations and writes the estimated amounts into the road surface condition map 118.

In step S712, a decision is made as to whether all the areas have been handled. If there is any untreated area, control goes back to step S701, where a next area is reselected and steps S701-S711 are repeated. If the processing of all the areas is completed, control proceeds to step S713.

In step S713, the rut estimating portion 117 erases data in the all vehicle trajectory database 113 and data in the currently measured road surface condition map 116 in which new road surface information is fully reflected. Data in the most newly updated road surface condition map 118 is copied into the previous road surface condition map 607, thus terminating the processing. The central unit 109 repeats the above-described processing at regular intervals such that the newest road surface conditions are reflected in the road surface condition map 118.

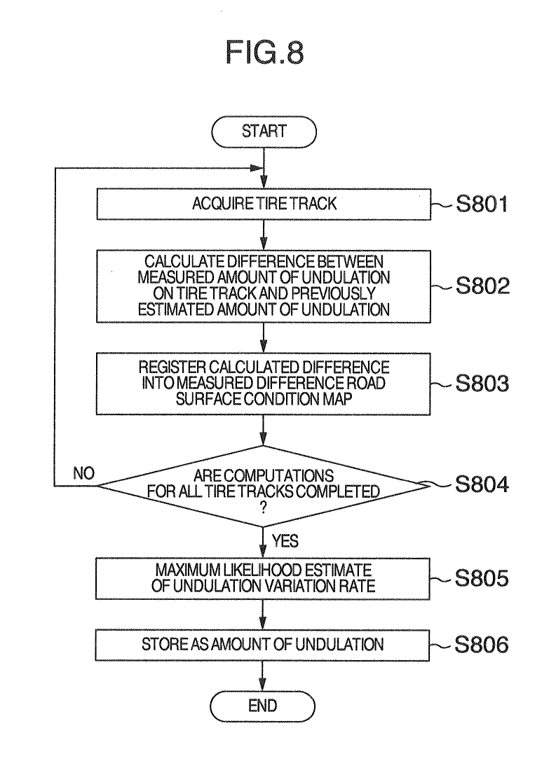

A flowchart illustrating processing steps for estimating the undulation variation rate that is an amount of variation of undulation caused by a single run of the vehicle is shown in FIG. 8. The present processing routine is carried out after the completion of the processing routine of FIG. 7 until the next period of a rut estimation operation comes. It is considered that an amount of variation of undulation due to a single run of the vehicle depends on the hardness of the road and other factors. In the present invention, it is assumed that the hardness of the road is constant throughout all the areas. An undulation variation rate 1₀(j, m) in a range in of weights of vehicle body in an area with area number j is found.

First, in step S801, the measurement-estimated difference calculating portion 608 reads the position sequence of the tire track calculated by the tire track calculating portion 602 in step S703 of FIG. 7 from the tire track calculating portion 602.

Then, in step S802, the measurement-estimated difference calculating portion 608 selects one tire track position sequence and calculates the difference between the measured amount of undulation on the tire track and the previous amount of estimated undulation. Tire track position sequences are selected in turn from the sequence having the minimum number. The measured amount of undulation on the tire track is the amount of undulation within the subject area of the currently measured road surface condition map 116 at the tire track position point calculated by the tire track calculating portion 602. The previous amount of estimated undulation is an estimated amount of undulation within the subject area of the previous road surface condition map 607 at the tire track position point computed by the tire track calculating portion 602.

In a case where any measured amount of undulation cannot be obtained, calculations are performed on the assumption that the difference with the previous amount of estimated undulation is constant.

In step S803, the measurement-estimated difference calculating portion 608 writes the results of the calculation performed in step S802 into the measured difference road surface condition map 609 and then a decision is made as to whether steps S802 and S803 have been performed for the position sequences of all the tire tracks in step S804. If there is any remaining tire track unprocessed, control goes back to step S802, where the processing is repeated. If the processing of all the tire tracks is completed, control proceeds to the next step S805.

Then, in step S805, the measurement-estimated difference maximum likelihood estimating portion 610 finds the undulation variation rate from the difference between the measured undulation amount registered in the measured difference road surface condition map 609 and the previous estimated amount of undulation. A maximum likelihood estimate of the undulation variation rate 1₀ is calculated by successively applying a weighted least squares method as given by Eq. (3) n times.

$${1}_{0} ( j , m ) = {1}_{0} ( j , m ) + \frac{φ ( M ) n ( L - {1}_{0} )}{1 + φ ( M ) n} \qquad ( 3 )$$

where L is a measured amount of undulation (in m), M is the weight (in kg) of the body of the vehicle, 1₀ (j, m) is an undulation variation rate to which the weight M of the body corresponds in an area with area number j, m is a classification of the weight M of the body, n is the number of measurements of undulations, and φ(M) is a dispersion value of the measured amount of undulation.

Since the measured amount of undulation L varies according to the weight M of the body of the vehicle, the estimate is found under the assumption that the dispersion value of the measured amount of undulation L is φ(M). It is assumed that the φ(M) assumes a normal distribution which is maximized when the weight M of the body is the unloaded vehicle weight M₀. The φ(M) is given by

$$φ ( M ) = \frac{1}{\sqrt{2 π} M} {e}^{- \frac{{( M - {M}_{0} )}^{2}}{2}} \qquad ( 4 )$$

where φ(M) is a dispersion value of a measured amount of undulation, M is the weight (in kg) of the body of the vehicle, and M₀ is the unloaded vehicle weight (in kg).

It is assumed that the unloaded vehicle weight M₀ is known for each vehicle and recorded in the all vehicle specification database 114 for each individual vehicle.

The undulation variation rate 1₀ (j, m) obtained here is stored as an undulation variation rate for the classification m corresponding to the range of vehicle body weights in the area with area number j into the undulation variation rate storage portion 611 in step S806 and used for the processing performed by the undulation amount estimating portion 604 in the next rut estimating processing interval.

When the rut estimating portion of the central unit is used, during a truck operation simulation in a mine or the like, the present invention can be applied to an apparatus or device for estimating at what timing a grader should be introduced.

It should be further understood by those skilled in the art that although the foregoing description has been made on embodiments of the invention, the invention is not limited thereto and various changes and modifications may be made without departing from the spirit of the invention and the scope of the appended claims.

1. A road surface condition estimating device having a vehicle information acquisition unit which acquires behavioral information about behavior of plural vehicles collected during their travel, the collected information including information about positions, postures, and travel speeds of the vehicles, and an all vehicle trajectory database which stores trajectories of positions traveled by the vehicles, said road surface condition estimating device comprising:
undulation estimating unit which estimates undulations on the trajectories of the positions traveled by the vehicles from the behavioral information about the vehicles; and
a rut estimating unit which estimates undulations of ruts relative to the trajectories of the vehicles from the trajectories of the positions traveled by the vehicles and from the behavioral information about the vehicles;
wherein undulations on the trajectory of each traveling vehicle found by the undulation estimating unit and undulations of ruts relative to the trajectory of the traveling vehicle found by the rut estimating unit are superimposed for each vehicle to find road surface conditions and the found conditions are delivered to the vehicles.

2. The road surface condition estimating device of claim 1, wherein said rut estimating portion has a vehicle behavior estimating unit which estimates behavior including turns or rapid acceleration or deceleration of the vehicles from said behavioral information obtained during travel of the vehicles and an undulation estimating unit which estimates undulations of ruts created by behavior of the vehicles from an undulation variation rate owing to the difference between an amount of undulation estimated from the behavior of the vehicles and a previously found amount of undulation.

3. The road surface condition estimating device of claim 2, wherein said rut estimating unit has a measurement-estimated difference maximum likelihood estimating unit which calculates the difference between the amount of undulation estimated from behavior of each vehicle and an amount of undulation found previously and finding an undulation variation rate that is an amount of undulation produced by a single run of a vehicle.

4. The road surface condition estimating device of claim 3, wherein, when any amount of undulation estimated from behavior of a vehicle cannot be obtained, said measurement-estimated difference maximum likelihood estimating unit performs calculations on the assumption that the undulation variation rate is constant.

5. A method of estimating road surface conditions which obtains behavioral information about plural vehicles collected during travel of the vehicles, storing trajectories of positions traveled by the vehicles, and finding road surface conditions, said behavioral information including information about positions, postures, and travel speeds of the vehicles, said method comprising the steps of:
estimating undulations on the trajectories of positions traveled by the vehicles from the behavioral information about the vehicles;
estimating undulations of ruts relative to the trajectories of the vehicles from the trajectories of the positions traveled by the vehicles and from the behavioral information about the vehicles; and
superimposing the undulations on the trajectories of the traveling vehicles and the undulations of the ruts relative to the trajectories of the traveling vehicle to find road surface conditions and distributing the road surface conditions to the vehicles.

6. The method of estimating road surface conditions as set forth in claim 5, wherein said step of estimating undulations of ruts includes estimating behavior of the vehicles including turns or rapid acceleration or deceleration of the vehicles from the behavioral information obtained during travel of the vehicles and estimating undulations of ruts produced by behavior of the vehicles from an undulation variation rate owing to the difference between an amount of undulation estimated from the behavior of the vehicles and a previously found amount of undulation.

7. The method of estimating road surface conditions as set forth in claim 6, wherein said step of estimating undulations of ruts includes calculating the difference between an amount of undulation estimated from behavior of the vehicles and a previously found amount of undulation and finding an undulation variation rate that is an amount of undulation produced by a single run of a vehicle.

8. The method of estimating road surface conditions as set forth in claim 7, wherein in said step of finding an undulation variation rate, calculations are performed on the assumption that the undulation variation rate is constant provided that any amount of undulation estimated from behavior of the vehicles cannot be obtained.
